(19) United States
(12) Patent Application Publication
(10) Pub. No.: US 2017/0014963 A1
(43) Pub. Date: Jan. 19, 2017

(54) Lathe

(71) Applicant: DMG MORI CO., LTD., Nara (JP)

(72) Inventor: Koji Tsuchimochi, Nara (JP)

(73) Assignee: DMG MORI CO., LTD., Nara (JP)

(21) Appl. No.: 15/199,211

(22) Filed: Jun. 30, 2016

(30) Foreign Application Priority Data
Jul. 14, 2015 (JP) 2015-140287

(51) Int. Cl. B23Q 17/00; B23Q 15/013; G05B 19/4155; B23B 13/12

(52) U.S. Cl. CPC B23Q 17/002; B23B 13/126; B23Q 15/013; G05B 19/4155; G05B 2219/36204; G05B 2219/45124

(57) ABSTRACT

A lathe 1 includes a first tool rest 10 and a second tool rest 20 disposed to face each other with a spindle axis between them and is configured to, when machining a workpiece W with a tool attached to the first tool rest 10, support the portion to be machined of the workpiece W at a side opposite to the portion to be machined of the workpiece W with a support member 28 attached to the second tool rest 20. A servo motor 24 that moves the second tool rest 20 when supporting the workpiece W is supplied with a current within a preset limiting range. The limiting range is previously set based on a current value detected by driving the servo motor 24 to move the second tool rest 20 and detecting a value of a current supplied to the servo motor 24 during the movement.

### BACKGROUND

Field of the Disclosure

The present disclosure relates to a lathe including a spindle device that holds a workpiece and rotates the workpiece about an axis, and two movable bodies, i.e. first and second movable bodies, that each hold a tool and are disposed to face each other with an axis of the spindle device between them, more particularly relates to a lathe configured so that, when the workpiece is machined by a tool held by one of the movable bodies, a portion to be machined of the workpiece is supported at a side opposite to the portion to be machined thereof by a support member held by the other of the movable bodies.

Background of the Disclosure

A hitherto known example of the above-mentioned lathe is a combined machining lathe disclosed in Japanese Unexamined Patent Application Publication No. 2008-254118. This combined machining lathe includes a first spindle holding a workpiece, a second spindle disposed to face the first spindle, an upper tool rest disposed above a center line connecting the first spindle and the second spindle, and a lower tool rest disposed below the center line connecting the first spindle and the second spindle, and the lower tool rest includes a workpiece supporting device that supports the workpiece at a lower side of the workpiece.

Further, the workpiece supporting device is composed of, for example, a workpiece supporting holder that is detachably attached to the lower tool rest, and a workpiece supporting member that is attached to the workpiece supporting holder and brought into contact with the workpiece. Furthermore, the workpiece supporting device may have a spherical portion at a distal end thereof which is brought into contact with the workpiece, or may include a spring mechanism provided between the workpiece supporting holder and the workpiece supporting member. Further, the workpiece supporting force can be controlled by controlling the torque of a servo motor provided for axially feeding the lower tool rest.

Thus, according to this combined machining lathe, because the lower tool rest includes the workpiece supporting device, occurrence of chatter vibration can be prevented by supporting the workpiece at an appropriate position on the workpiece W, particularly when milling or the like is performed on an elongated workpiece. Further, the workpiece supporting force can be appropriately controlled by controlling the torque of the servo motor provided for axially feeding the lower tool rest.

### SUMMARY OF THE DISCLOSURE

By the way, although not disclosed in much detail in Japanese Unexamined Patent Application Publication No. 2008-254118, conventionally, the above-mentioned appropriate control of the torque of the servo motor is typically performed by setting an upper limit on the output torque of the servo motor. The servo motor is controlled so that the output torque thereof does not exceed the upper limit, whereby the workpiece supporting force is prevented from becoming too large, in other words, the workpiece is prevented from being deformed due to an excessive supporting force acting thereon. Note that the upper limit of the output torque is set taking into account a torque required for moving the tool rest and a torque equivalent to a supporting force for appropriately supporting the workpiece.

However, the torque required for moving the tool rest, that is, an appropriate output torque which should be output by the servo motor varies in accordance with the weight of the tool rest to be moved through a feed shaft and a resistance value of a guide unit guiding the movement of the tool rest, i.e. load acting on the servo motor. Therefore, there is a problem that the value of the torque required for moving the tool rest cannot be uniformly set and therefore the upper limit of the output torque cannot be appropriately set based on the torque.

For example, the types and the number of tools (including tool holders) attached to the tool rest depend on the details of the machining of the workpiece; therefore, the weight of the tool rest varies in accordance with machining to be executed. Further, the resistance value of the guide unit changes with time because of degradation of guiding performance of the guide unit due to wear and the like; therefore, the resistance value cannot be uniformly set.

The present disclosure has been achieved in view of the above-described circumstances, and an object thereof is to provide a lathe capable of always appropriately setting a supporting force for supporting a portion on a side opposite to a portion to be machined of a workpiece with a support member at the time of machining.

The present invention, for solving the above-described problem, relates to a lathe including:

a spindle device having a spindle holding a workpiece, and rotating the workpiece about an axis of the spindle;

a first movable body and a second movable body each capable of holding a tool, the first and second movable bodies being disposed to face each other with the axis of the spindle between them and provided to be movable in a plane including a first axis parallel to the axis of the spindle and a second axis perpendicular to the first axis;

a first feed mechanism for moving the first movable body in a direction along the first axis and a direction along the second axis;

a second feed mechanism for moving the second movable body in the direction along the first axis and the direction along the second axis; and

a controller controlling the spindle device, the first feed mechanism, and the second feed mechanism,

the first and second feed mechanisms each having a first-axis servo motor for moving the first movable body or the second movable body in the direction along the first axis and a second-axis servo motor for moving the first movable body or the second movable body in the direction along the second axis,

the controller being configured to, when driving one of the first and second feed mechanisms and thereby moving one of the first and second movable bodies corresponding to the one of the first and second feed mechanisms to machine the workpiece with a tool disposed on the one of the first and second movable bodies, drive the other of the first and second feed mechanisms and thereby move the other of the first and second movable bodies corresponding to the other of the first and second feed mechanisms to support a portion to be machined of the workpiece at a side opposite to the portion to be machined of the workpiece with a support member disposed on the other of the movable bodies, and being configured to, when supporting the workpiece, supply a current within a preset limiting range to the second-axis servo motor of the other of the first and second feed mechanisms, and

the controller being further configured to previously execute a load detecting operation of driving the second-axis servo motor of the other of the first and second feed mechanisms and thereby moving the other of the first and second movable bodies in the direction along the second axis, detect a value of a current supplied to said second-axis servo motor during the load detecting operation, and perform a processing for setting the limiting range based on the detected value of the current.

According to the lathe of the present disclosure having the above-described configuration, first, a limiting range of a current supplied to the second-axis servo motor of the other of the feed mechanisms is set by the controller in advance of execution of machining under control by the controller. That is, the controller executes an operation (load detecting operation) of driving the second-axis servo motor of the other of the feed mechanisms and thereby moving the other of the movable bodies in the second-axis direction and detects a value of the current supplied to the second-axis servo motor in this operation, and sets the limiting range based on the detected value of the current.

The current value detected at the time of the load detecting operation corresponds to a torque which should be output by the second-axis servo motor when the other of the movable bodies is moved in the second-axis direction, in other words, the detected current value is equivalent to the output torque. The limiting range is set taking into account this output torque (which is equivalent to the detected current value) and a torque equivalent to a supporting force for appropriately supporting the workpiece (a current value corresponding to the supporting force (support current value)). More specifically, for example, in a case where the other of the movable bodies is movable in the vertical direction and the workpiece is supported upwardly by moving the other of the movable bodies upward, a value obtained by adding the support current value to the detected current value is designated as an upper limit, while in a case where the workpiece is supported downwardly by moving the other of the movable bodies downward, a value obtained by subtracting the support current value from the detected current value is designated as a lower limit.

Further, after the limiting range of the current supplied to the second-axis servo motor of the other of the feed mechanisms is set by the controller in the above-described manner, under control by the controller, the one of the movable bodies is driven by the one of the feed mechanisms corresponding thereto and thereby the workpiece is machined by a tool disposed on the one of the movable bodies, while the other of the movable bodies is driven by the other of the feed mechanisms corresponding thereto and thereby a portion to be machined of the workpiece is supported at a side opposite to the portion to be machined thereof by a support member disposed on the other of the movable bodies. In this process, the second-axis servo motor of the other of the feed mechanisms is supplied with a current within the previously set limiting range.

Thus, according to the lathe of the present invention, when a workpiece is machined by a tool disposed on one of the movable bodies, a portion to be machined of the workpiece is supported at a side opposite to the portion to be machined thereof by a support member disposed on the other of the movable bodies. Therefore, occurrence of chatter vibration and the like on the workpiece can be prevented similarly to the conventional art.

Further, a limiting range of the current supplied to the second-axis servo motor of the other of the feed mechanisms can be set immediately before execution of the machining; therefore, when the support member disposed on the other of the movable bodies is caused to support the workpiece, supplying a current within the previously set limiting range to the second-axis servo motor of the other of the feed mechanisms allows the workpiece to be supported with an appropriate supporting force. Accordingly, it is possible to prevent occurrence of a trouble that the workpiece is deformed due to the workpiece being supported with an excessive supporting force.

That is, as previously mentioned, the weight of the other of the movable bodies varies in accordance with the details of the machining of the workpiece because the types and the number of tools (including tool holders) attached to the other of the movable bodies depend on the details of the machining of the workpiece; furthermore, a resistance value of a guide unit guiding the other of the movable bodies changes with time. Therefore, it is preferred that the limiting range of the current supplied to the second-axis servo motor of the other of the feed mechanisms is appropriately set immediately before execution of the machining. According to the lathe of the present invention, as described above, the limiting range can be set immediately before execution of machining; therefore, the workpiece can be supported with an appropriate supporting force.

Note that, in the present invention, the controller may be configured to include:

a load detecting operation executor driving the second-axis servo motor of the other of the first and second feed mechanisms and thereby moving the other of the first and second movable bodies in the direction along the second axis;

a load detector detecting a value of the current supplied to the second-axis servo motor during operation of the load detecting operation executor; and

a limiting range setter setting the limiting range based on the value of the current detected by the load detector.

According to the controller having the above-described configuration, the load detecting operation executor executes a load detecting operation of driving the second-axis servo motor of the other of the feed mechanisms and thereby moving the other of the movable bodies in the second-axis direction, the load detector detects a value of the current supplied to the second-axis servo motor during this load detecting operation, and the limiting range setter sets the limiting range based on the detected current value.

Further, the limiting range setter may be configured to calculate the limiting range by adding a predetermined value to the current value detected by the load detector or subtracting a predetermined value from the current value detected by the load detector.

As described above, for example, in the case where the other of the movable bodies is movable in the vertical direction and the workpiece is supported upwardly by moving the other of the movable bodies upward, a value obtained by adding a predetermined value to the detected current value is designated as an upper limit (limiting range), while in the case where the workpiece is supported downwardly by moving the other of the movable bodies downward, a value obtained by subtracting a predetermined value from the detected current value is designated as a lower limit (limiting range).

Further, in the present invention, it is preferred that the controller is configured to, when driving the other of the feed mechanisms to support the workpiece with the support member, detect a deviation from a target moving position in the second-axis direction for the other of the movable bodies, and control the second-axis servo motor of the other of the feed mechanisms so that the other of the movable bodies is stopped at its present position when the detected deviation exceeds a predetermined permissible deviation.

In the present invention, the value of the current supplied to the second-axis servo motor of the other of the movable bodies is limited within the limiting range; therefore, when the support member is brought into contact with the workpiece, deviation from a target moving position is gradually increased because the other of the movable bodies cannot move in the second-axis direction any more. In such a case, if a current is continuously supplied to the second-axis servo motor, energy will be wasted. Accordingly, controlling the second-axis servo motor so that the other of the movable bodies is stopped at its present position when the deviation exceeds a predetermined permissible deviation enables suppressing such waste of energy.

As described above, according to the lathe of the present invention, when a workpiece is machined by a tool disposed on one of the movable bodies, a portion to be machined of the workpiece is supported at a side opposite to the portion to be machined thereof by a support member disposed on the other of the movable bodies. Therefore, occurrence of chatter vibration and the like on the workpiece can be prevented.

Further, a limiting range of the current supplied to the second-axis servo motor of the other of the feed mechanisms can be set immediately before execution of the machining; therefore, when the support member disposed on the other of the movable bodies is caused to support the workpiece, supplying a current within the thus set limiting range to the second-axis servo motor of the other of the feed mechanisms allows the workpiece to be supported with an appropriate supporting force. Accordingly, it is possible to prevent occurrence of a trouble that the workpiece is deformed due to the workpiece being supported with an excessive supporting force.

### BRIEF DESCRIPTION OF THE DRAWINGS

For a more complete understanding of the disclosed methods and apparatus, reference should be made to the embodiment illustrated in greater detail on the accompanying drawings, wherein:

FIG. 1 is an illustration showing a schematic configuration of a lathe according to a first embodiment of the present invention;

FIG. 2 is a block diagram showing a schematic configuration of a controller according to the first embodiment;

FIG. 3 is an illustration for illustrating setting of a current limiting range according to the first embodiment;

FIG. 4 is an illustration showing a schematic configuration of a lathe according to a second embodiment of the present invention;

FIG. 5 is a block diagram showing a schematic configuration of a controller according to the second embodiment; and

FIG. 6 is an illustration for illustrating setting of a current limiting range according to the second embodiment.

### DETAILED DESCRIPTION

Hereinafter, specific embodiments of the present disclosure will be described with reference to the drawings.

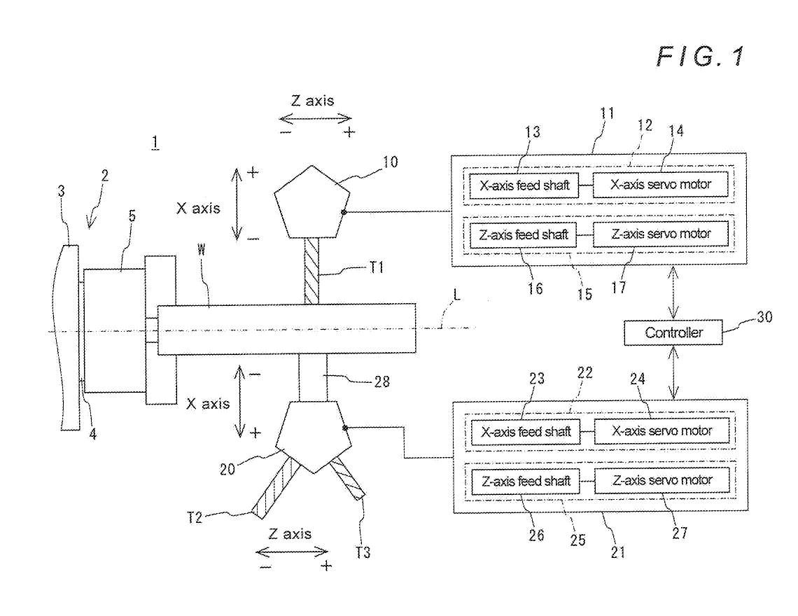

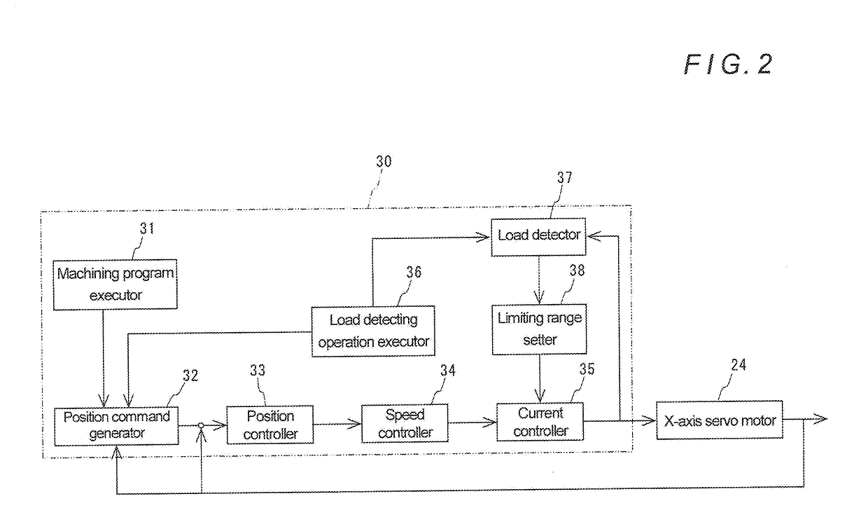

First, a first embodiment of the present disclosures described. FIG. 1 is an illustration showing a schematic configuration of a lathe according to this first embodiment and FIG. 2 is a block diagram showing a schematic configuration of a controller according to this first embodiment.

As shown in FIG. 1, a lathe 1 according to this embodiment is composed of a spindle device 2, a first tool rest 10, a second tool rest 20, a first feed mechanism 11 for moving the first tool rest 10, a second feed mechanism 21 for moving the second tool rest 20, a controller 30 controlling the spindle device 2, the first feed mechanism 11, and the second feed mechanism 21, and other components.

The spindle device 2 includes a spindle 4, a headstock 3 by which the spindle 4 is rotatably retained, a chuck 5 mounted on a front end surface of the spindle 4 for holding a workpiece W, a spindle motor (not shown) rotating the spindle 4 about an axis L of the spindle 4

The first tool rest 10 and the second tool rest 20 are vertically aligned one above the other; the first tool rest 10 is disposed above the axis L of the spindle 4 and the second tool rest 20 is disposed below the axis L of the spindle 4. Note that, in this embodiment, a tool T1 is attached to the first tool rest 10 and tools T2 and T3 are attached to the second tool rest 20, and the workpiece W is machined by these tools T1, T2, and T3. However, as a matter of course, this is merely an example and the present disclosures not limited to this. Further, the second tool rest 20 has a support member 28 attached thereto besides the tools T2 and T3.

The first feed mechanism 11 is composed of a first X-axis feed mechanism 12 having an X-axis feed shaft 13 and an X-axis servo motor 14, and a first Z-axis feed mechanism 15 having a Z-axis feed shaft 16 and a Z-axis servo motor 17, and moves the first tool rest 10 in the direction along an X axis, which is along the vertical direction, with the first X-axis feed mechanism 12 and moves the first tool rest 10 in the direction along a Z axis, which is perpendicular to the X axis and is along the axis L of the spindle 4, with the first Z-axis feed mechanism 15.

Similarly, the second feed mechanism 21 is composed of a second X-axis feed mechanism 22 having an X-axis feed shaft 23 and an X-axis servo motor 24, and a second Z-axis feed mechanism 25 having a Z-axis feed shaft 26 and a Z-axis servo motor 27, and moves the second tool rest 20 in the X-axis direction with the second X-axis feed mechanism 22 and moves the second tool rest 20 in the Z-axis direction with the second Z-axis feed mechanism 25. Note that the X-axis feed shafts 13 and 23 and the Z-axis feed shafts 16 and 26 are each composed of a well-known ball screw mechanism or the like.

Thus, the first tool rest 10 is moved in an X-Z plane, which is formed by the X axis and the Z axis, by first feed mechanism 11 and the second tool rest 20 is moved in the X-Z plane by the second feed mechanism 21.

The controller 30 controls the spindle motor (not shown) of the spindle device 2, the X-axis servo motor 14 and the Z-axis servo motor 17 of the first feed mechanism 11, and the X-axis servo motor 24 and the Z-axis servo motor 27 of the second feed mechanism 21.

As shown in FIG. 2, the controller 30 according to this embodiment includes a machining program executor 31, a position command generator 32, a position controller 33, a speed controller 34, a current controller 35, a load detecting operation executor 36, a load detector 37, a limiting range setter 38, and other units.

Note that the position controller 33, the speed controller 34, and the current controller 35, which are shown in FIG. 2, are functional units that control the X-axis servo motor 24 of the second X-axis feed mechanism 22, and, as a matter of course, each of the X-axis servo motor 14 of the first X-axis feed mechanism 12, the Z-axis servo motor 17 of the first Z-axis feed mechanism 15, and the Z-axis servo motor 27 of the second Z-axis feed mechanism 25 also requires functional units corresponding to the position controller 33, the speed controller 34, and the current controller 35. However, in this embodiment, depiction and description of such functional units are omitted for the sake of convenience. Similarly, although functional units controlling the spindle motor (not shown) of the spindle device 2 are also naturally required, depiction and description thereof are also omitted for the sake of convenience.

The machining program executor 31 is a functional unit that starts a processing upon receipt of an appropriate execution command to execute an appropriate machining program. The machining program executor 31 analyzes the machining program and recognizes moving positions and feed speeds for the first X-axis feed mechanism 12, the first Z-axis feed mechanism 15, the second X-axis feed mechanism 22, and the second Z-axis feed mechanism 25, and transmits the recognized moving positions and feed speeds to the position command generator 32. Further, the machining program executor 31 recognizes commands for the spindle motor (not shown) and transmits the recognized commands to a functional unit (not shown) controlling the spindle motor (not shown).

Note that machining operations executed by the machining program executor 31 include a supporting operation of, when the first tool rest 10 is driven by the first feed mechanism 11 to machine the workpiece W with the tool T1 attached to the first tool rest 10, moving the second tool rest 20 in the negative X-axis direction with the second feed mechanism 21 so as to bring the support member 28 attached to the second tool rest 20 into contact with a side opposite to the portion to be machined by the tool T1 of the workpiece W to support the workpiece W.

The position command generator 32 generates position commands for the first X-axis feed mechanism 12, the first Z-axis feed mechanism 15, the second X-axis feed mechanism 22, and the second Z-axis feed mechanism 25 based on the moving positions and feed speeds for the first X-axis feed mechanism 12, the first Z-axis feed mechanism 15, the second X-axis feed mechanism 22, and the second Z-axis feed mechanism 25, which are received from the machining program executor 31. The position command generator 32 transmits the generated position command for the second X-axis feed mechanism 22 to the position controller 33 and transmits the generated position commands for the first X-axis feed mechanism 12, the first Z-axis feed mechanism 15, and the second Z-axis feed mechanism 25 to their respective corresponding position controllers (not shown).

The position controller 33 generates a speed command in accordance with the positon command received from the position command generator 32 and transmits the generated speed command to the speed controller 34, the speed controller 34 generates a current command in accordance with the received speed command and transmits the generated current command to the current controller 35, and the current controller 35 generates a drive current in accordance with the received current command and supplies the generated drive current to the X-axis servo motor 24. Consequently, the X-axis servo motor 24 is driven by the thus supplied drive current.

Further, the X-axis servo motor 24 has a rotary encoder attached thereto, and a deviation (error) between an actual position that is detected by the rotary encoder and the commanded position is fed back to the position command and this deviation is transmitted also to the position command generator 32. Note that, in this embodiment, once the transmitted deviation exceeds a permissible deviation, the generation of the position command by the position command generator 32 is stopped and the rotation of the X-axis feed shaft 23 is locked by an appropriate braking mechanism.

The load detecting operation executor 36 is a functional unit that starts a processing upon receipt of an appropriate execution command to transmit a detection start signal to the load detector 37 and execute an operation program for load detection. This operation program for load detection is a program for performing an operation of initially moving the second tool rest 20 to an initial position, at which the support member 28 is sufficiently spaced from the workpiece W so as not to interfere with the workpiece W, in a state where the support member 28 is indexed at a rotational position at which it can support the workpiece W, and an operation of moving the second tool rest 20 to a detection position, which is set at a position in the negative X-axis direction with respect to the initial position and at which the support member 28 is not in contact with the workpiece W, at a predetermined speed.

The load detecting operation executor 36 executes the above-described operation program for load detection and transmits moving positions and feed speeds for the second X-axis feed mechanism 22 and the second Z-axis feed mechanism 25 to the position command generator 32. The position command generator 32 generates position commands for the second X-axis feed mechanism 22 and the second Z-axis feed mechanism 25 based on the moving positions and feed speeds received from the load detecting operation executor 36 and transmits the generated position command for the second X-axis feed mechanism 22 to the position controller 33 and the generated position command for the second Z-axis feed mechanism 25 to its corresponding position controller (not shown).

The load detector 37 is a functional unit that detects a value of the current supplied from the current controller 35 to the X-axis servo motor 24 while the operation program for load detection is executed by the load detecting operation executor 36 and thereby the second tool rest 20 is moved in the negative X-axis direction (upward) from the initial position to the detection position.

The limiting range setter 38 is a functional unit that sets, based on the current value detected by the load detector 37, a range for limiting the value of the current supplied from the current controller 35 to the X-axis servo motor 24. The limiting range is set in order to, when the supporting operation of moving the second tool rest 20 in the negative X-axis direction (upward) with the second X-axis feed mechanism 22 of the second feed mechanism 21 to support the workpiece W with the support member 28 attached to the second tool rest 20 is performed, limit the value of the current supplied to the X-axis servo motor 24 so that the support member 28 does not push the workpiece W with an excessive force.

The current value detected by the load detector 37 corresponds to a torque which should be output by the X-axis servo motor 24 when the second tool rest 20 is moved in the negative X-axis direction, that is, the detected current value is equivalent to the output torque. The limiting range setter 38 sets the limiting range taking into account this output torque (which is equivalent to the detected current value) and a torque equivalent to a supporting force for appropriately supporting the workpiece W (equivalent to a current value corresponding to the supporting force (support current value)).

By the way, the current value detected by the load detector 37 while the second tool rest 20 is moved in the negative X-axis direction (upward) from the initial position to the detection position depends on the weight of the second tool rest 20 and frictional resistance of a guide unit of the second tool rest 20.

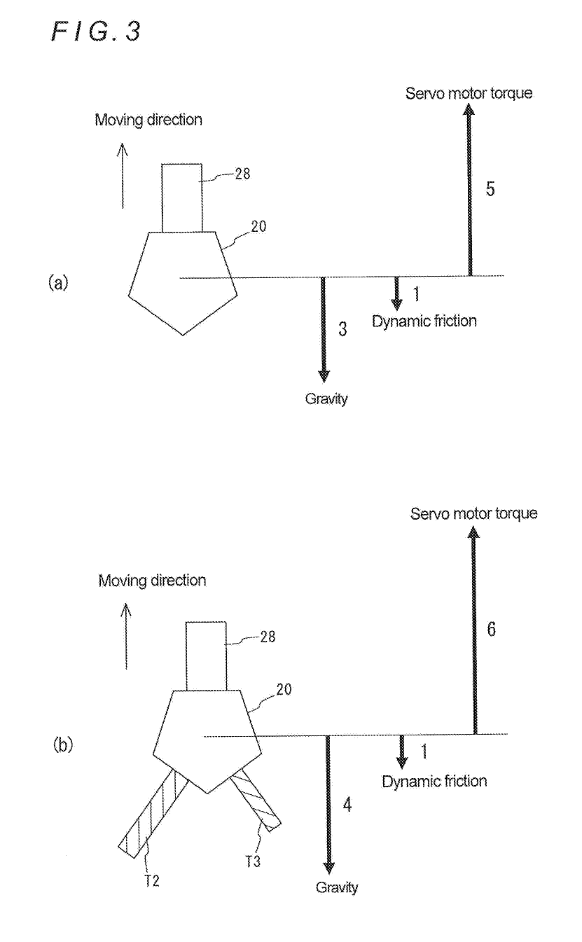

For example, as shown in FIG. 3(a), in a case where only the support member 28 is attached to the second tool rest 20, when the torque required for supporting the gravity of the second tool rest 20 is “3” and the torque corresponding to dynamic friction of the guide unit and the torque required for moving the second tool rest 20 are respectively “1” and “1”, the torque which should be output by the X-axis servo motor 24 when the second tool rest 20 is moved in the negative X-axis direction (upward) is “5”, which is obtained by adding together the gravity-equivalent torque “3”, the dynamic-friction-equivalent torque “1”, and the torque required for movement “1”. On the other hand, as shown in FIG. 3(b), if the tools T2 and T3 besides the support member 28 are attached to the second tool rest 20 and thereby the gravity-equivalent torque is increased to “4”, the torque which should be output by the X-axis servo motor 24 becomes “6”, which is obtained by adding the dynamic-friction-equivalent torque “1” and the torque required for movement “1” to the gravity-equivalent torque “4”. Note that the examples shown in FIG. 3 are merely conceptual ones for explaining that the current to be supplied to the X-axis servo motor 24 depends on the weight of the second tool rest 20 and frictional resistance of the guide unit.

As described above, the current supplied to the X-axis servo motor 24 when the second tool rest 20 is moved in the negative X-axis direction (upward) depends on the weight of the second tool rest 20 and the frictional resistance of the guide unit. However, in this embodiment, the current supplied from the current controller 35 to the X-axis servo motor 24 is detected by the load detector 37 when the second tool rest 20 is actually moved in the negative X-axis direction (upward); therefore, the current to be supplied to the X-axis servo motor 24 for moving the second tool rest 20 in the negative X-axis direction (upward) can be accurately recognized.

To the thus accurately recognized current value required for moving the second tool rest 20 in the negative X-axis direction (upward), the limiting range setter 38 adds the support current value that is equivalent to the supporting force for appropriately supporting the workpiece W with the support member 28, thereby setting an upper limit as the limiting range.

According to the lathe 1 of this embodiment having the above-described configuration, before machining is executed by the machining program executor 31, the operation program for load detection is executed by the load detecting operation executor 36, and, upon execution of this operation program, a value of the current supplied from the current controller 35 to the X-axis servo motor 24 is detected by the load detector 37 while the second tool rest 20 is moved in the negative X-axis direction (upward) from the initial position to the detection position. Further, the limiting range setter 38 sets an upper current value limit as the limiting range by adding the support current value to the detected current value.

After the upper limit of the current supplied from the current controller 35 to the X-axis servo motor 24 is set in the above-described manner, the machining is executed by the machining program executor 31. That is, the first feed mechanism 11, the second feed mechanism 21, and the spindle motor (not shown) are driven in accordance with a machining program, whereby the workpiece W held by the chuck 5 is machined by the tool T1 attached to the first tool rest 10 and the tools T2 and T3 attached to the second tool rest 20.

In this machining, when the first tool rest 10 is driven by the first feed mechanism 11 to machine the workpiece W with the tool T1 attached to the first tool rest 10, the supporting operation of moving the second tool rest 20 in the negative X-axis direction (upward) with the second feed mechanism 21 so as to bring the support member 28 attached to the second tool rest 20 into contact with a portion on a side opposite to the portion to be machined by the tool T1 of the workpiece W to support the workpiece W is executed.

If the support member 28 is brought into contact with the workpiece W during the execution of the supporting operation, that is, before the second tool rest 20 reaches a target position which is designated as a support position, a positioning error becomes larger, which causes the current controller 35 to gradually increase the current supplied to the X-axis servo motor 24 in order to correct the positioning error. However, because the current supplied to the X-axis servo motor 24 is limited by the limiting range setter 38, the current controller 35 supplies a current not more than the upper limit set by the limiting range setter 38 to the X-axis servo motor 24.

Thus, according to the lathe 1 of this embodiment, when the workpiece W is machined by the tool T1 attached to the first tool rest 10, the portion to be machined of the workpiece W is supported at a side opposite to the portion to be machined thereof by the support member 28 attached to the second tool rest 20. Therefore, occurrence of chatter vibration and the like on the workpiece W can be prevented.

Further, when the workpiece W is supported by the support member 28 attached to the second tool rest 20, because an upper limit of the current supplied to the X-axis servo motor 24 that drives the second tool rest 20 can be set immediately before execution of the machining, supplying a current not more than the set upper limit to the X-axis servo motor 24 allows the workpiece W to be supported with an appropriate supporting force. Therefore, it is possible to prevent occurrence of a trouble that the workpiece W is deformed due to the workpiece W being supported with an excessive supporting force.

As described above, the weight of the second tool rest 20 depends on the details of the machining of the workpiece W because the types and the number of tools attached to the second tool rest 20 depend on the details of the machining of the workpiece W; furthermore, a resistance value of the guide unit guiding the movement of the second tool rest 20 changes with time. Therefore, it is preferred that the upper limit of the current supplied to the X-axis servo motor 24 is appropriately set immediately before execution of the machining. According to the lathe 1 of this embodiment, as described above, the upper limit can be set immediately before execution of the machining; therefore, the workpiece W can be supported with an appropriate supporting force.

Further, as described above, if the support member 28 is brought into contact with the workpiece W before the second tool rest 20 reaches a target position which is designated as a support positon, a positioning error (deviation) becomes larger. However, in the lathe 1 of this embodiment, once the deviation exceeds a permissible deviation, the generation of the position command by the position command generator 32 is stopped and the rotation of the X-axis feed shaft 23 is locked by an appropriate braking mechanism, whereby the second tool rest 20 is stopped at its present position.

In the lathe 1 of this embodiment, because the magnitude of the current supplied from the current controller 35 to the X-axis servo motor 24 is limited, the support member 28 is stopped from pushing the workpiece W with an excessive force after the support member 28 is brought into contact with the workpiece W, which prevents deformation of the workpiece W. However, if a current not more than the upper limit is continuously supplied to the X-axis servo motor 24, energy therefor will be wasted. Accordingly, the lathe 1 is configured to, when the deviation exceeds a predetermined permissible deviation, stop the generation of the position command by the position command generator 32 and lock the rotation of the X-axis feed shaft 23 with an appropriate braking mechanism so as to stop the second tool rest 20, which enables suppressing such waste of energy.

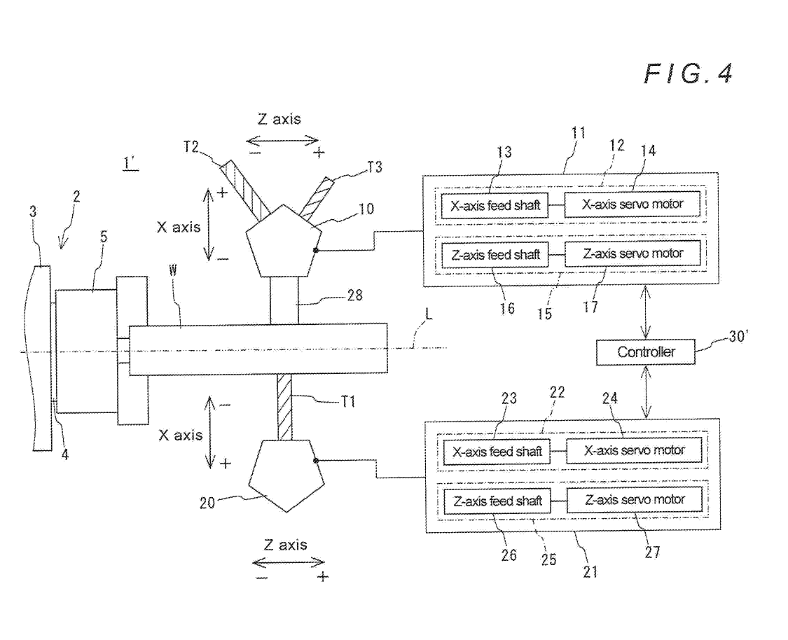

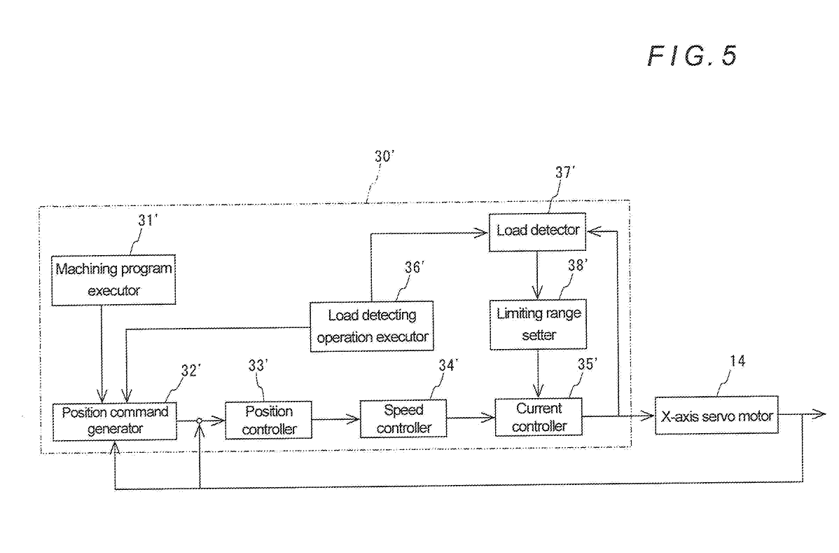

Next, a second embodiment of the present disclosures described. FIG. 4 is an illustration showing a schematic configuration of a lathe according to this second embodiment and FIG. 5 is a block diagram showing a schematic configuration of a controller according to this second embodiment.

As shown in FIG. 4, a lathe 1′ according to the second embodiment is configured to support a workpiece W with a support member 28 attached to a first tool rest 10 located above the workpiece W when machining the workpiece W with a tool T1 attached to a second tool rest 20 located below the workpiece W. Note that the components which are the same as those of the above-described lathe 1 are denoted by the same reference numerals in FIGS. 4 and 5 and detailed description thereof is omitted in the following description.

As shown in FIG. 5, a controller 30′ of the lathe 1′ includes a machining program executor 31′, a position command generator 32′, a position controller 33′, a speed controller 34′, a current controller 35′, a load detecting operation executor 36′, a load detector 37′, a limiting range setter 38′, and other units.

Similarly to the machining program executor 31 in the first embodiment, the machining program executor 31′ starts a processing upon receipt of an appropriate execution command to execute an appropriate machining program. Machining operations executed include a supporting operation of, when the second tool rest 20 is driven by a second feed mechanism 21 to machine the workpiece W with the tool T1 attached to the second tool rest 20, moving the first tool rest 10 in the negative X-axis direction (downward) with a first feed mechanism 11 so as to bring the support member 28 attached to the first tool rest 10 into contact with a side opposite to the portion to be machined by the tool T1 of the workpiece W to support the workpiece W.

The position controller 33′, the speed controller 34′, and the current controller 35′ correspond to the position controller 33, the speed controller 34, and the current controller 35 in the first embodiment, respectively, and control an X-axis servo motor 14 of a first X-axis feed mechanism 12; their substantive processings are the same as the processings of the position controller 33, the speed controller 34, and the current controller 35 in the first embodiment. Further, the position command generator 32′ corresponds to the position command generator 32 in the first embodiment and its substantive processing is the same as the processing of the position command generator 32 in the first embodiment.

Similarly to the load detecting operation executor 36 in the first embodiment, the load detecting operation executor 36′ starts a processing upon receipt of an appropriate execution command to transmit a detection start signal to the load detector 37′ and execute an operation program for load detection. This operation program for load detection is a program for performing an operation of initially moving the first tool rest 10 to an initial position, at which the support member 28 is sufficiently spaced from the workpiece W so as not to interfere with the workpiece W, in a state where the support member 28 is indexed at a rotational position at which it can support the workpiece W, and an operation of moving the first tool rest 10 to a detection position, which is set at a position in the negative X-axis direction with respect to the initial position and at which the support member 28 is not in contact with the workpiece W, at a predetermined speed.

The load detecting operation executor 36′ executes the operation program for load detection and transmits moving positions and feed speeds for the first X-axis feed mechanism 12 and a first Z-axis feed mechanism 15 to the position command generator 32′. The position command generator 32′ generates position commands for the first X-axis feed mechanism 12 and the first Z-axis feed mechanism 15 based on the moving positions and feed speeds received from the load detecting operation executor 36′, and transmits the generated position command for the first X-axis feed mechanism 12 to the position controller 33′ and the generated position command for the first Z-axis feed mechanism 15 to its corresponding position controller (not shown).

The load detector 37′ detects a value of the current supplied from the current controller 35′ to the X-axis servo motor 14 while the operation program for load detection is executed by the load detecting operation executor 36′ and thereby the first tool rest 10 is moved in the negative X-axis direction (downward) from the initial position to the detection position.

The limiting range setter 38′ sets, based on the current value detected by the load detector 37′, a range for limiting the value of the current supplied from the current controller 35′ to the X-axis servo motor 14. This limiting range is set in order to, when the supporting operation of moving the first tool rest 10 in the negative X-axis direction with the first X-axis feed mechanism 12 of the first feed mechanism 11 to support the workpiece W with the support member 28 attached to the first tool rest 10 is performed, limit the value of the current supplied to the X-axis servo motor 14 so that the support member 28 does not push the workpiece W with an excessive force.

The current value detected by the load detector 37′ corresponds to a torque which should be output by the X-axis servo motor 14 when the first tool rest 10 is moved in the negative X-axis direction, that is, the detected current value is equivalent to the output torque. The limiting range setter 38′ sets the limiting range taking into account this output torque (which is equivalent to the detected current value) and a torque equivalent to the supporting force for appropriately supporting the workpiece W (a current value corresponding to the supporting force (support current value)).

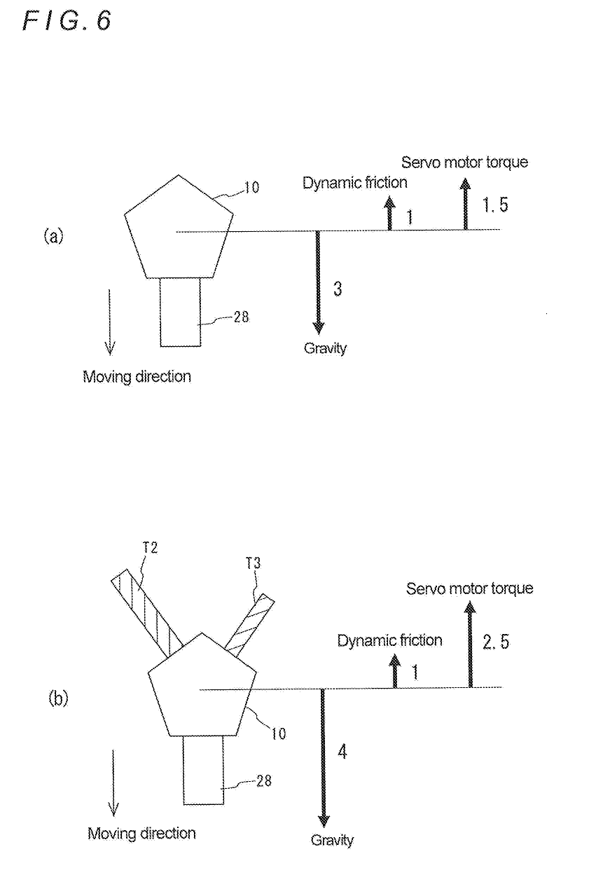

In this lathe 1′, for example, as shown in FIG. 6(a), in a case where only the support member 28 is attached to the first tool rest 10, when the torque required for supporting the gravity of the first tool rest 10 is “3” and the torque corresponding to dynamic friction of a guide unit of the first tool rest 10 and the torque required for moving the first tool rest 10 are respectively “−1” and “−0.5”, the torque which should be output by the X-axis servo motor 14 when the first tool rest 10 is moved in the negative X-axis direction (downward) is “1.5”,which is obtained by adding together the gravity-equivalent torque “3”, the dynamic-friction-equivalent torque “4”, and the torque required for movement “−0.5”. On the other hand, as shown in FIG. 6(b), if tools T2 and T3 besides the support member 28 are attached to the first tool rest 10 and thereby the gravity-equivalent torque is increased to “4”, the torque which should be output by the X-axis servo motor 14 becomes “2.5”, which is obtained by adding the dynamic-friction-equivalent torque “−1” and the torque required for movement “−0.5” to the gravity-equivalent torque “4”. Note that the examples shown in FIG. 6 are merely conceptual ones for explaining that the current to be supplied to the X-axis servo motor 14 depends on the weight of the first tool rest 10 and frictional resistance of the guide unit.

Thus, the current supplied to the X-axis servo motor 14 when the first tool rest 10 is moved in the negative X-axis direction (downward) depends on the weight of the first tool rest 10 and frictional resistance of the guide unit thereof. However, in this embodiment, the current supplied from the current controller 35′ to the X-axis servo motor 14 is detected by the load detector 37′ when the first tool rest 10 is actually moved in the negative X-axis direction (downward); therefore, the current to be supplied to the X-axis servo motor 14 for moving the first tool rest 10 in the negative X-axis direction (downward) can be accurately recognized.

From the thus accurately recognized current value required for moving the first tool rest 10 in the negative X-axis direction (downward), the limiting range setter 38′ subtracts the support current value that is equivalent to the supporting force for appropriately supporting the workpiece W with the support member 28, thereby setting a lower limit as the limiting range.

Thus, also in this lathe 1′, when the workpiece W is machined by the tool T1 attached to the second tool rest 20, the portion to be machined of the workpiece W is supported at a side opposite to the portion to be machined of the workpiece W by the support member 28 attached to the first tool rest 10; therefore, occurrence of chatter vibration and the like on the workpiece W can be prevented.

Further, when the workpiece W is supported by the support member 28 attached to the first tool rest 10, because a lower limit of the current supplied to the X-axis servo motor 14 that drives the first tool rest 10 can be set immediately before execution of the machining, supplying a current not less than the set lower limit to the X-axis servo motor 14 allows the workpiece W to be supported with an appropriate supporting force. Therefore, it is possible to prevent occurrence of a trouble that the workpiece W is deformed due to the workpiece W being supported with an excessive supporting force.

Note that, also in this lathe 1′, if the support member 28 is brought into contact with the workpiece W before the first tool rest 10 reaches a target position which is designated as a support position and thereby the positioning error (deviation) exceeds a permissible deviation, the generation of the position command by the position command generator 32′ is stopped and the rotation of the X-axis feed shaft 13 is locked by an appropriate braking mechanism, whereby the first tool rest 10 is stopped at its present position. In this way, as described above, waste of energy is suppressed.

Thus, specific embodiments of the present disclosure have been described above; however, the present disclosure is not limited thereto and may be implemented in other specific embodiments.

For example, although, in the lathe 1 and the lathe 1′ of the above-described embodiments, the first tool rest 10 and the second tool rest 20 are aligned vertically, the present disclosure is not limited to this configuration and a so-called slant type lathe is also possible in which the first tool rest 10 and the second tool rest 20 are aligned obliquely. Alternatively, the first tool rest 10 and the second tool rest 20 may be aligned horizontally.

In such cases, the limiting range set by the limiting range setter 38 (38′) is determined in accordance with the sign of the torque equivalent to the supporting force for supporting the workpiece W with the support member 28 with an appropriate supporting force. In the case where the sign of the torque is positive, an upper limit is set by adding a current value equivalent to the supporting force to the current value detected by the load detector 37 (37′), while in the case where the sign of the torque is negative, a lower limit is set by subtracting a current value equivalent to the supporting force from the current value detected by the load detector 37 (37′).

Further, a lathe having a configuration obtained by combining the first embodiment and the second embodiment is possible. In such a case, a support member 28 is attached to each of the first tool rest 10 and the second tool rest 20, and when a workpiece W is machined by a tool attached to the first tool rest 10, the workpiece W is supported by the support member 28 attached to the second tool rest 20, while when the workpiece W is machined by a tool attached to the second tool rest 20, the workpiece W is supported by the support member 28 attached to the first tool rest 10.

Furthermore, the first tool rest 10 and the second tool rest 20 include a spindle rotating a tool, that is, a so-called tool spindle.

What is claimed is:

1. A lathe comprising:
a spindle device having a spindle holding a workpiece, and rotating the workpiece about an axis of the spindle;
a first movable body and a second movable body each capable of holding a tool, the first and second movable bodies being disposed to face each other with the axis of the spindle between them and provided to be movable in a plane including a first axis parallel to the axis of the spindle and a second axis perpendicular to the first axis;
a first feed mechanism for moving the first movable body in a direction along the first axis and a direction along the second axis;
a second feed mechanism for moving the second movable body in the direction along the first axis and the direction along the second axis; and
a controller controlling the spindle device, the first feed mechanism, and the second feed mechanism,
the first and second feed mechanisms each including a first-axis servo motor for moving the first movable body or the second movable body in the direction along the first axis and a second-axis servo motor for moving the first movable body or the second movable body in the direction along the second axis,
the controller being configured to, when driving one of the first and second feed mechanisms and thereby moving one of the first and second movable bodies corresponding to the one of the first and second feed mechanisms to machine the workpiece with a tool disposed on the one of the first and second movable bodies, drive the other of the first and second feed mechanisms and thereby move the other of the first and second movable bodies corresponding to the other of the first and second feed mechanisms to support a portion to be machined of the workpiece at a side opposite to the portion to be machined of the workpiece with a support member disposed on the other of the movable bodies, and being configured to, when supporting the workpiece, supply a current within a preset limiting range to the second-axis servo motor of the other of the first and second feed mechanisms, and
the controller being further configured to previously execute a load detecting operation of driving the second-axis servo motor of the other of the first and second feed mechanisms and thereby moving the other of the first and second movable bodies in the direction along the second axis, detect a value of a current supplied to said second-axis servo motor during the load detecting operation, and perform a processing for setting the limiting range based on the detected value of the current.

2. The lathe according to claim 1, wherein the controller includes:
a load detecting operation executor driving the second-axis servo motor of the other of the first and second feed mechanisms and thereby moving the other of the first and second movable bodies in the direction along the second axis;
a load detector detecting a value of the current supplied to the second-axis servo motor during operation of the load detecting operation executor; and
a limiting range setter setting the limiting range based on the value of the current detected by the load detector.

3. The lathe according to claim 2, wherein the limiting range setter is configured to calculate the limiting range by adding a predetermined value to the value of the current detected by the load detector or subtracting a predetermined value from the value of the current detected by the load detector.

4. The lathe according to claim 1, wherein the controller is configured to, when driving the other of the first and second feed mechanisms to support the workpiece with the support member, detect a deviation from a target moving position in the direction along the second axis for the other of the first and second movable bodies, and control the second-axis servo motor of the other of the first and second feed mechanisms so that the other of the first and second movable bodies is stopped at its present position when the detected deviation exceeds a predetermined permissible deviation.

5. The lathe according to claim 2, wherein the controller is configured to, when driving the other of the first and second feed mechanisms to support the workpiece with the support member, detect a deviation from a target moving position in the direction along the second axis for the other of the first and second movable bodies, and control the second-axis servo motor of the other of the first and second feed mechanisms so that the other of the first and second movable bodies is stopped at its present position when the detected deviation exceeds a predetermined permissible deviation.

6. The lathe according to claim 3, wherein the controller is configured to, when driving the other of the first and second feed mechanisms to support the workpiece with the support member, detect a deviation from a target moving position in the direction along the second axis for the other of the first and second movable bodies, and control the second-axis servo motor of the other of the first and second feed mechanisms so that the other of the first and second movable bodies is stopped at its present position when the detected deviation exceeds a predetermined permissible deviation.
